(19) United States
(12) Patent Application Publication
(10) Pub. No.: US 2026/0189557 A1
(43) Pub. Date: Jul. 2, 2026

(54) MACHINE LEARNING AGENT WITH SEMANTIC ENTITLEMENT

(71) Applicant: Microsoft Technology Licensing, LLC, Redmond, WA (US)

(72) Inventors: Brian Scott KRABACH, Snohomish, WA (US); Samuel Edward SCHILLACE, Portola Valley, CA (US)

(73) Assignee: Microsoft Technology Licensing, LLC, Redmond, WA (US)

(21) Appl. No.: 19/003,641

(22) Filed: Dec. 27, 2024

(51) Int. Cl. H04L 9/40; G06F 16/22

(52) U.S. Cl. CPC H04L 63/10; G06F 16/2237

(57) ABSTRACT

A computing system including one or more processing devices configured to receive a semantic entitlement that semantically specifies an access permission scope of a machine learning (ML) agent included in an ML system. The semantic entitlement has a natural language format. At least in part by processing the semantic entitlement at a generative language model included in the ML system, the one or more processing devices identify one or more resources that are included in the access permission scope indicated in the semantic entitlement. The one or more processing devices grant an ML agent of the plurality of ML agents access to the one or more identified resources. At the ML agent, the one or more processing devices compute an agent output based at least in part on the one or more identified resources. The one or more processing devices output the agent output to an additional computing process.

### BACKGROUND

In computing environments that have multiple different users, those users typically have different sets of access permissions. Access permissions are used to protect those users' confidential data by controlling which users can interact with which sets of data, and what sets of actions those users are allowed to perform. For example, a first user may have permission to read, edit, and copy a document, whereas a second user has read-only privileges and a third user is entirely blocked from accessing the document. Thus, a computing system may control access to confidential data such as trade secrets or personally identifying information.

The access permissions associated with a particular resource may be stored at the computing system as an access-control list (ACL) that specifies the privileges granted to each user for that resource. Alternatively, role-based access control (RBAC) may be used to specify user permissions. In RBAC, roles that have respective sets of access permissions are assigned to the users of the computing system.

### SUMMARY

According to one aspect of the present disclosure, a computing system is provided, including one or more processing devices configured to receive a semantic entitlement that semantically specifies an access permission scope of a machine learning (ML agent included in an ML system. The semantic entitlement has a natural language format. At least in part by processing the semantic entitlement at a generative language model included in the ML system, the one or more processing devices are further configured to identify one or more resources that are included in the access permission scope indicated in the semantic entitlement. The one or more processing devices are further configured to grant an ML agent of the plurality of ML agents access to the one or more identified resources. At the ML agent, the one or more processing devices are further configured to compute an agent output based at least in part on the one or more identified resources. The one or more processing devices are further configured to output the agent output to an additional computing process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1B schematically show an example computing system at which one or more processing devices are configured to execute an ML system, according to one example embodiment.

FIG. 2A schematically shows the computing system of when the one or more processing devices are configured to perform vector similarity matching to select one or more identified resources, according to the example of FIGS. 1A-1B.

FIG. 2B schematically shows the computing system when a plurality of predefined confidence thresholds used in the vector similarity matching are stored in one or more memory devices, according to the example of FIG. 2A.

FIG. 3 schematically shows the computing system when the one or more processing devices are configured to receive a first access request and generate a refusal description, according to the example of FIGS. 1A-1B.

FIG. 4 schematically shows the computing system in an example in which the one or more processing devices are configured to compute an annotated prompt based at least in part on the one or more identified resources, according to the example of FIGS. 1A-1B.

FIG. 5A shows a flowchart of a method for use with a computing system at which an ML system is executed, according to the example of FIGS. 1A-1B.

FIGS. 5B-5E show additional steps of the method of FIG. 5A that may be performed in some examples.

FIG. 6 shows a schematic view of an example computing environment in which the computing system of FIGS. 1A-1B may be instantiated.

### DETAILED DESCRIPTION

As the capabilities of machine learning (ML) models have advanced, those ML models have been incorporated into a variety of computing workflows. For example, ML models have been incorporated into ML agents that utilize those ML models in at least partially autonomous computing processes. An ML agent includes computer program instructions that specify conditions under which one or more ML models are executed, along with the inputs of those ML models. In some examples, the ML agent may be included in an ML system that includes multiple ML agents capable of interacting with each other. In addition, an ML agent may request user oversight or approval for some specified actions.

Traditional approaches to access permissions in computing environments, such as ACLs and RBAC, provide a static framework with which computing systems provide access to different resources. However, in computing systems that include ML agents, those ML agents may be configured to utilize a variety of different data sources and output channels. Existing access permission data structures such as ACLs and roles may be insufficiently specific to cover the types of resources and actions that are relevant to a task the ML agent performs while also satisfying data confidentiality requirements. In addition, the ML agent and its surrounding computing environment may change over time, for example, as a result of adding new files to a filesystem, modifying a confidentiality policy, or performing additional training at an ML model included in the ML agent. Conventional access control systems may require manual updating to account for such changes.

An ML agent may perform operations on resources at speeds and scales that would make frequent requests for user feedback impractical. For example, requesting user approval to access each file in a large directory may be very time-consuming for the user, especially if the user is not already familiar with the contents of those files. Requesting user feedback as a prerequisite to accessing a resource may also interrupt a user's workflow, such as when an ML agent requests permission from a meeting organizer to join an ongoing meeting on a videoconferencing platform.

In one example, an organization includes multiple teams working on tented projects that are kept confidential from members of the organization outside their respective teams. A team maintains a filesystem directory that includes files related to a confidential project but also includes files that do not include confidential information. Using existing permission systems, an ML agent that the team uses to manage the directory would typically be unable to share the files in the directory outside of the directory, even if those files do not include confidential data. Providing the ML agent with such permissions using an ACL or role may require fine-grained user input specifying permissions associated with each of the files, which may be time-consuming for users to provide.

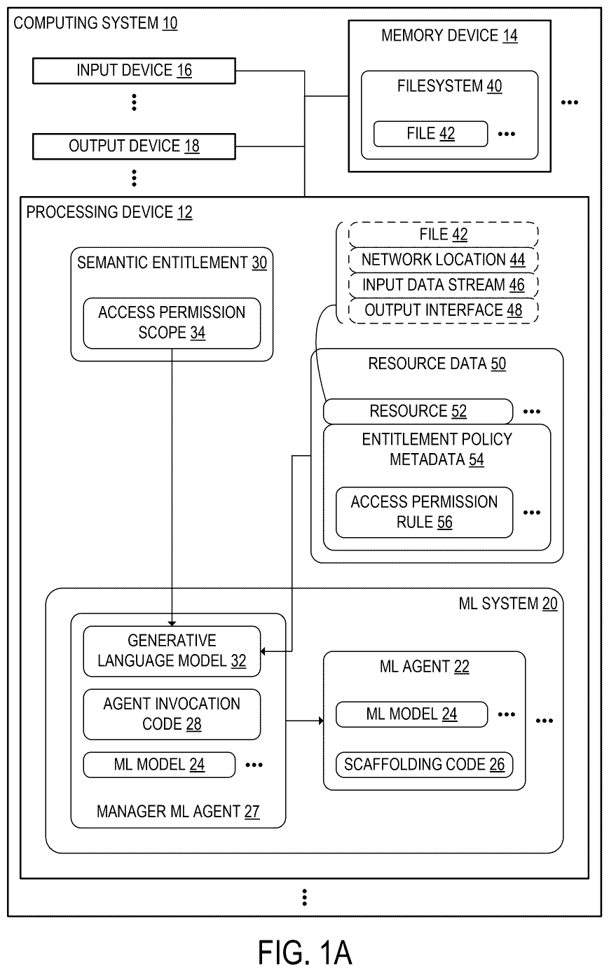

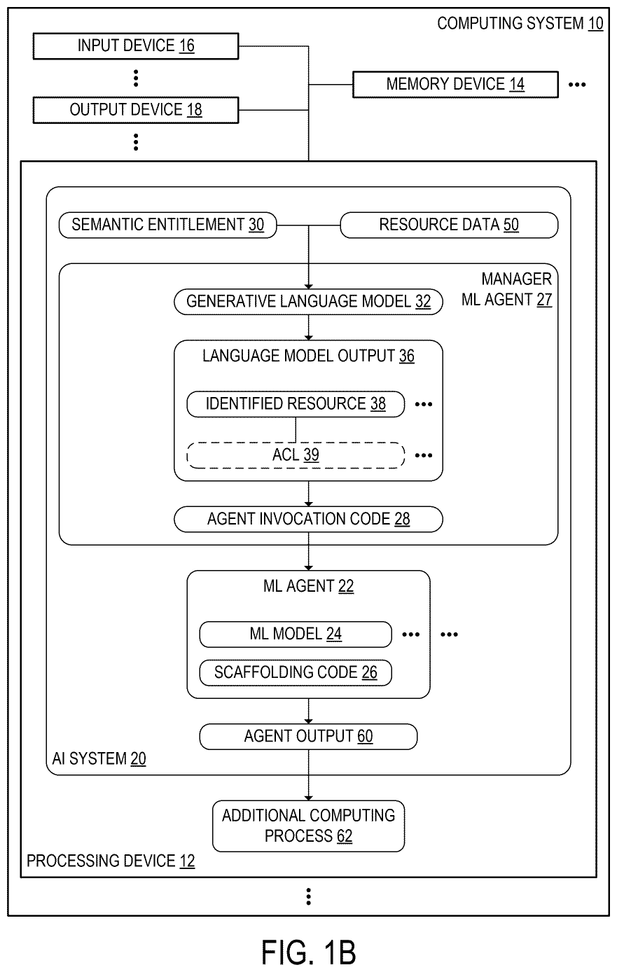

In order to address the above challenges, a computing system 10 is provided, as shown in the example of FIGS. 1A-1B. The computing system 10 of FIGS. 1A-1B includes one or more processing devices 12, one or more memory devices 14, one or more input devices 16, and one or more output devices 18. The one or more processing devices 12 may, for example, include one or more central processing units (CPUs), graphics processing units (GPUs), neural processing units (NPUs), and/or other types of hardware accelerators. The one or more memory devices 14 may, for example, include one or more volatile memory devices and one or more non-volatile storage devices. The one or more input devices 16 and the one or more output devices 18 are used to implement a user interface at which a user interacts with the computing system 10, as discussed in further detail below.

In some examples, the one or more processing devices 12, the one or more memory devices 14, the one or more input devices 16, and/or the one or more output devices 18 may be distributed among a plurality of different physical computing devices. For example, the physical computing devices included in the computing system 10 may have a server-client configuration. In other examples, the computing system 10 may be implemented at a single physical computing device.

The one or more processing devices 12 are configured to execute an ML system 20 that includes a plurality of ML agents 22. Each of the ML agents 22 includes one or more ML models 24 along with scaffolding code 26. The one or more processing devices 12 are configured to execute the scaffolding code 26 to determine when the one or more ML models 24 are executed and to select the inputs to those ML models 24. Preprocessing of those inputs and/or postprocessing of ML model outputs may also be performed by executing the scaffolding code 26. The one or more ML models 24 may, for example, include one or more large language models (LLMs) and/or large multimodal models (LMMs). For example, GPT-3, GPT-3.5, GPT-4o, Orca, LLaMA, Gemini, or Claude v1 may be used as the LLM or LMM. Further, it will be understood that language models of various parameter sizes may be used, with smaller models generally consuming fewer compute resources and offering lower latency and larger models consuming more resources and offering greater accuracy and expressiveness. The LLM may be fine-tuned using, for example, full finetuning, delta models, Low Rank Adaptation (LoRA) models, or other technique, to adapt the models for the task of evaluating semantic entitlements among a particular set of domains. Other types of ML models 24, such as computer vision models or audio processing models, may also be included in an ML agent 22.

In addition to the plurality of ML agents 22, the ML system 20 depicted in the example of FIGS. 1A-1B further includes agent invocation code 28 that the one or more processing devices 12 are configured to execute in order to determine when the different ML agents 22 are activated. Thus, the agent invocation code 28 may be executed as meta-level scaffolding code associated with the plurality of ML agents 22. In some examples, the agent invocation code 28 is included in a manager ML agent 27 that includes one or more ML models 24 and is configured to control the activation of the other ML agents 22 included in the ML system 20.

As shown in FIG. 1A, the one or more processing devices 12 are further configured to receive a semantic entitlement 30 that semantically specifies an access permission scope 34 of an ML agent 22 included in the ML system 20. The semantic entitlement 30 has a natural language format and may be received as a user input. For example, a user may input the semantic entitlement “Allow the slideshow generator agent to read documents in the Marketing folder that do not include financial data.” Another example semantic entitlement is “Grant the audio transcription agent access to the microphone during meetings, but only after all attendees have approved recording.” As shown in these examples, the semantic entitlement 30 may specify the access permission scope 34 using natural-language criteria that would be laborious for a user to construct according to a conventional approach such as ACLs or RBAC.

The one or more processing devices 12 are further configured to input the semantic entitlement 30 into a generative language model 32 included in the ML system 20. The generative language model 32 may be an LLM or an LMM. In some examples, one or more of the ML agents 22 included in the ML system 20 may also utilize the generative language model 32 for computing tasks other than processing the semantic entitlement 30. The one or more processing devices 12 may be configured to execute the generative language model 32 as part of the manager ML agent 27 when processing the semantic entitlement 30.

As an additional input, the generative language model 32 is further configured to receive resource data 50 that indicates a plurality of resources 52. In addition, the generative language model 32 may be further configured to receive entitlement policy metadata 54 that specifies one or more access permission rules 56 associated with the one or more resources 52. For example, the one or more access permission rules 56 associated with a resource 52 may include one or more ACLs and/or roles that refer to that resource 52.

The one or more resources 52 may each be a file 42 stored in a filesystem 40 at one or more memory devices 14; a network location 44 in a computer network; an input data stream 46 received at the computing system 10; or an output interface 48 of the computing system 10. In some examples, a plurality of files 42 or network locations 44 may be selected together, such as by selecting a directory of the filesystem 40. In examples in which the resource 52 is an input data stream 46, the one or more processing devices 12 may receive that input data stream 46 via the one or more input devices 16. In examples in which the resource 52 is an output interface 48, that output interface 48 may be an interface with an output device 18 of the one or more output devices 18. Other types of resources 52 not listed above may also be indicated in the resource data 50 in some examples.

At the generative language model 32, as shown in FIG. 1B, the one or more processing devices 12 are further configured to identify one or more resources 38 that are included in the access permission scope 34 indicated in the semantic entitlement 30. The one or more processing devices 12 are configured to compute a language model output 36 that includes the one or more identified resources 38. In some examples, the language model output 36 further includes one or more ACLs 39 that specify the one or more identified resources 38. Accordingly, in such examples, the generative language model 32 may be configured to perform code generation to compute a formal specification of the access permission scope 34 indicated in the semantic entitlement 30.

The one or more processing devices 12 are further configured to grant an ML agent 22 of the plurality of ML agents 22 access to the one or more identified resources 38. In the example of FIG. 1B, the generative language model 32 is executed at the manager ML agent 27, which is further configured to input the language model output 36 into the agent invocation code 28. By executing the agent invocation code 28 with the language model output 36 as an input, the one or more processing devices 12 may be further configured to launch an instance of the ML agent 22 that has access to the one or more identified resources 38.

At the ML agent 22, the one or more processing devices 12 are configured to compute an agent output 60 based at least in part on the one or more identified resources 38. For example, the one or more identified resources 38 may be used as an input at an ML model 24 included in the ML agent 22. In one example, at the ML agent 22, the one or more processing devices 12 may be configured to input a document received as an identified resource 38 into a generative language model 32 as part of a prompt, along with instructions for the generative language model 32 to summarize the document. Accordingly, the agent output 60 is a summary of the document in this example.

The one or more processing devices 12 are further configured to output the agent output 60 to an additional computing process 62. For example, the additional computing process 62 may be a user interface or another ML agent 22. In some examples, the one or more identified resources 38 may include the additional computing process 62 to which the agent output 60 is transmitted. In such examples, the identified resource 38 may be the destination of the agent output 60 or an application-programming interface (API) via which the one or more processing devices 12 are configured to transmit the agent output 60.

In some examples, subsequently to the initial computation of the language model output 36 that indicates the one or more identified resources 38, one or more additional resources 52 may be added to the computing system 10. These one or more additional resources 52 may be one or more files 42, network locations 44, input data streams 46, and/or output interfaces 48, as discussed above. In response to receiving the one or more additional resources, 52 the one or more processing devices 12 may be further configured to recompute the one or more identified resources 38 at least in part by executing the generative language model 32. Respective indications of the one or more additional resources 52 are included in the prompt in such examples. Thus, as the resource data 50 is updated, the one or more processing devices 12 may be configured to programmatically recompute the one or more identified resources 38. For example, the one or more processing devices 12 may be configured to update the one or more identified resources 38 at a predefined time interval.

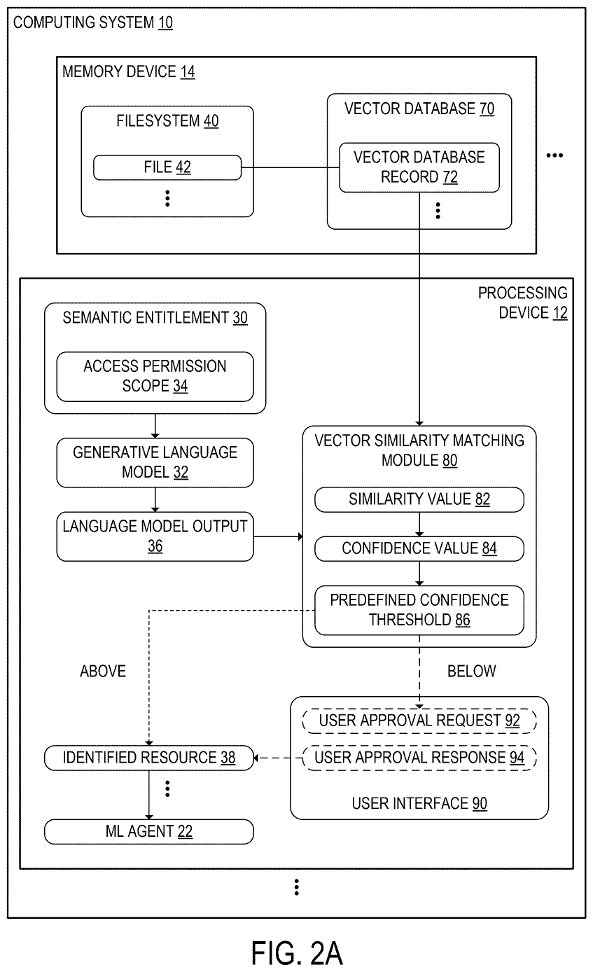

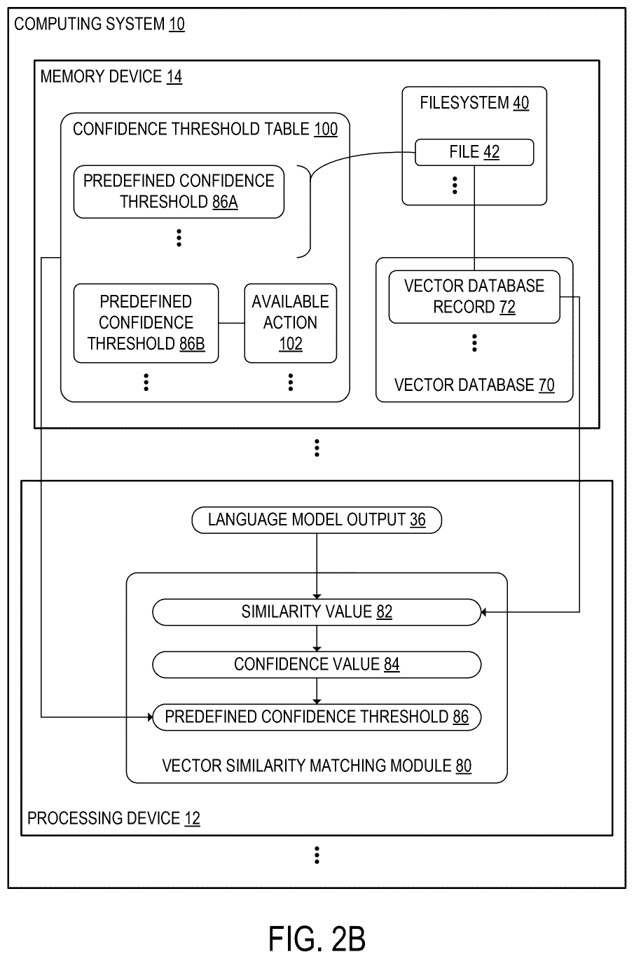

In some examples, as shown in FIG. 2A, the one or more processing devices 12 are configured to perform vector similarity matching in order to select the one or more identified resources 38. In the example of FIG. 2A, the one or more identified resources 38 include one or more files 42 stored in the filesystem 40. The one or more memory devices 14 further store a vector database 70 including respective vector database records 72 of the one or more files 42.

The one or more processing devices 12 are further configured to execute a vector similarity matching module 80. At the vector similarity matching module 80, the one or more processing devices 12 are configured to identify the one or more files 42 that match the semantic entitlement 30 at least in part by performing vector similarity matching between the vector database records 72 and the language model output 36. For example, the one or more processing devices 12 may be configured to identify one or more vector database records 72 that have the top k cosine similarity values to the language model output 36, for some predetermined value of k.

In the example of FIG. 2A, for each of the one or more identified files 42, the one or more processing devices 12 are further configured to compute a respective confidence value 84 of the vector similarity matching. The one or more processing devices 12 are further configured to determine, for at least one of the identified files 42, that the confidence value 84 is below a predefined confidence threshold 86.

In response to determining that the confidence value 84 is below the predefined confidence threshold 86, the one or more processing devices 12 are further configured to output a user approval request 92 to a user interface 90 prior to granting the ML agent 22 access to the one or more identified resources 38. The one or more processing devices 12 may be further configured to receive a user approval response 94 via the user interface 90 subsequently to outputting the user approval request 92. In response to receiving the user approval response 94, the one or more processing devices 12 may be further configured to grant the ML agent 22 access to the one or more identified resources 38. Alternatively, the user may deny the ML agent 22 access to at least one of the one or more identified resources 38.

In some examples, rather than outputting a user approval request 92 in response to determining that the confidence value 84 is below the predefined confidence threshold 86, the one or more processing devices 12 may instead be configured to programmatically deny the ML agent 22 access to the one or more identified resources 38.

In some examples, as shown in FIG. 2B, the predefined confidence threshold 86 may be included among a plurality of different predefined confidence thresholds 86. The one or more memory devices 14 further store a confidence threshold table 100 that includes the plurality of predefined confidence thresholds 86. For example, the confidence threshold table 100 may store a plurality of predefined confidence thresholds 86A respectively associated with the files 42 included in the filesystem 40. Thus, different files 42 may have different confidence values at which the one or more processing devices 12 request user input, for example, due to whether those files 42 include information marked as confidential. Additionally or alternatively, the confidence threshold table 100 may store a plurality of different predefined confidence thresholds 86B associated with respective sets of available actions 102 performable by the ML agent 22 on the one or more identified files 42. For example, the confidence threshold table 100 may include different respective confidence thresholds 86B associated with reading a file 42, editing the file 42, and copying the file 42 to another location.

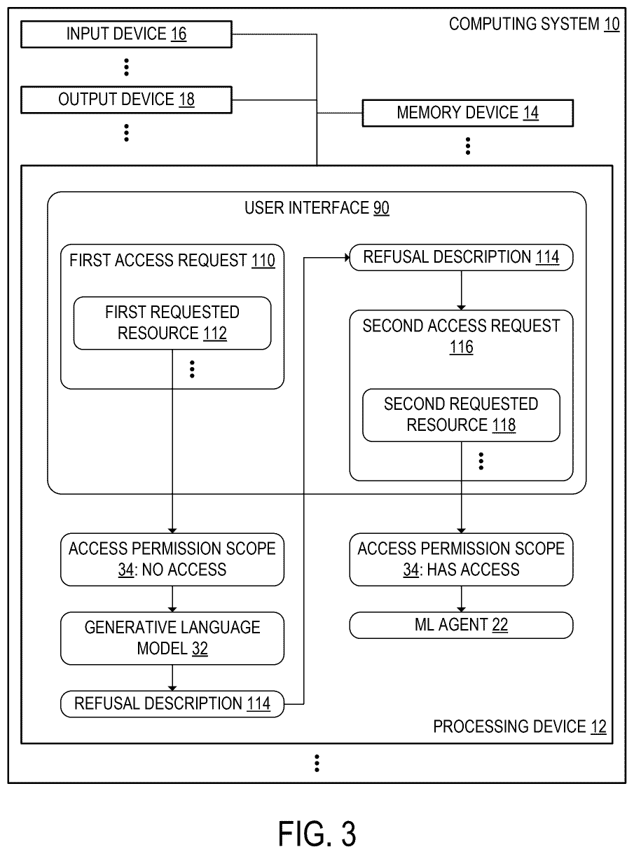

FIG. 3 schematically shows the computing system 10 when the one or more processing devices 12 receive a first access request 110 from the user over the user interface 90. For example, the user who makes the first access request 110 may be a user whose role does not give the user permission to set the entitlements of the ML agent 22. The first access request 110 specifies one or more first requested resources 112 that the user instructs the ML system 20 to make accessible to the ML agent 22.

The one or more processing devices 12 are further configured to determine, based at least in part on the semantic entitlement 30, that the ML agent 22 does not have access to at least one of the first requested resources 112 specified in the first access request 110. In the example of FIG. 3, the one or more processing devices 12 are configured to determine that the first requested resource 112 is not included in the access permission scope 34 of the semantic entitlement 30.

In response to determining that the ML agent 22 does not have access to the first requested resource 112, the one or more processing devices 12 are further configured to compute a refusal description 114 at least in part by executing the generative language model 32. The one or more processing devices 12 are configured to compute the refusal description 114 based at least in part on the semantic entitlement 30 and the first access request 110, which are included in a prompt of the generative language model 32. The refusal description 114 has the natural language format. An example refusal description 114 is “You instructed the research and development assistant agent to visit an Internet site. However, the research and development assistant agent only has permission to access intranet addresses.” The one or more processing devices 12 are further configured to output the refusal description 114. The refusal description 114 is output to the user interface 90 in the example of FIG. 3. By computing and outputting a natural-language refusal description 114, the one or more processing devices 12 are configured to present the user with an explanation of the refusal that may be easier to understand than a conventional error message.

In some examples, as shown in FIG. 3, subsequently to outputting the refusal description 114, the one or more processing devices 12 are further configured to receive a second access request 116 that specifies one or more second requested resources 118. The second access request 116 excludes the at least one first requested resource 112 to which the ML agent 22 does not have access, as specified in the access permission scope 34.

In response to receiving the second access request 116, the one or more processing devices 12 are further configured to determine that the one or more second requested resources 118 are within the access permission scope 34. In response to determining that the one or more second requested resources 118 are within the access permission scope 34, the one or more processing devices 12 are further configured to grant the ML agent 22 access to the one or more second requested resources 118. Accordingly, the user may update the first access request 110 to a second access request 116 in which all requested resources are within the access permission scope 34.

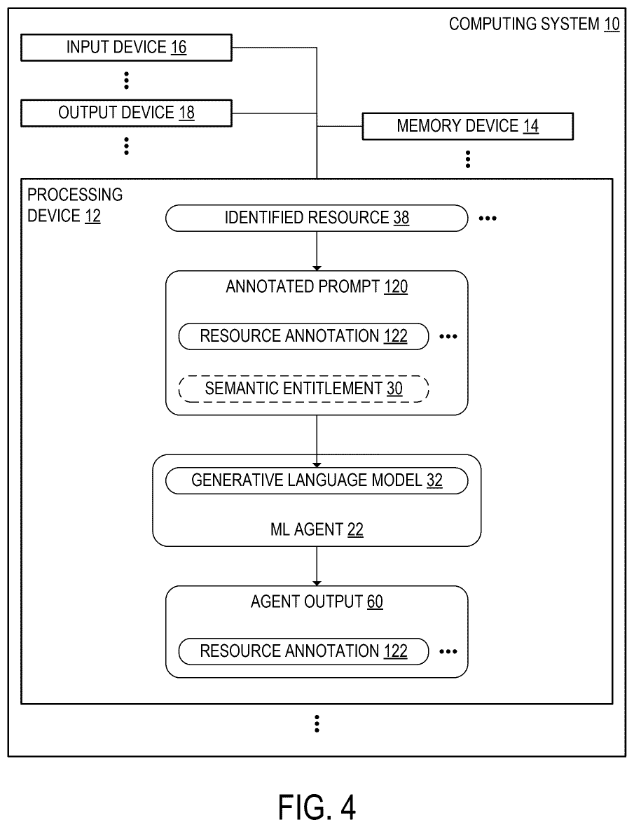

FIG. 4 schematically shows the computing system 10 in an example in which the one or more processing devices 12 are configured to compute an annotated prompt 120 based at least in part on the one or more identified resources 38. The annotated prompt 120 includes one or more resource annotations 122 that indicate the one or more identified resources 38. In some examples, the semantic entitlement 30 may also be included in the annotated prompt 120.

The one or more processing devices 12 are further configured to compute the agent output 60 of the ML agent 22 at least in part by executing the generative language model 32 with the annotated prompt 120. The agent output 60 includes the one or more resource annotations 122 in the example of FIG. 4. Thus, in the example of FIG. 4, the agent output 60 is tagged with metadata indicating the one or more identified resources with which the ML agent 22 computed the agent output 60. For example, when the one or more identified resources 38 are input sources, the one or more resource annotations 122 may be used to track the availability of different sources of input to the different ML agents 22 during execution of the ML system 20. Such attributions may, for example, be used in debugging to determine when an ML agent 22 is missing intended input sources or has access to unintended input sources. In examples in which the one or more identified resources 38 include one or more output interfaces 48, the one or more resource annotations 122 may be used to manage access to those output interfaces 48 by multiple computing processes, such as for purposes of allocating access to an oversubscribed output channel.

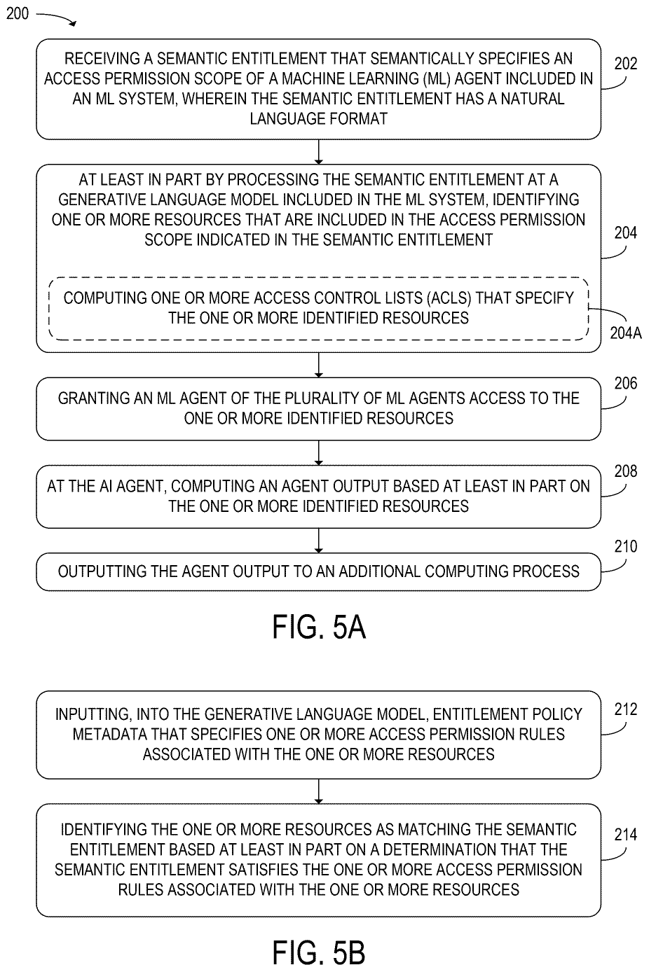

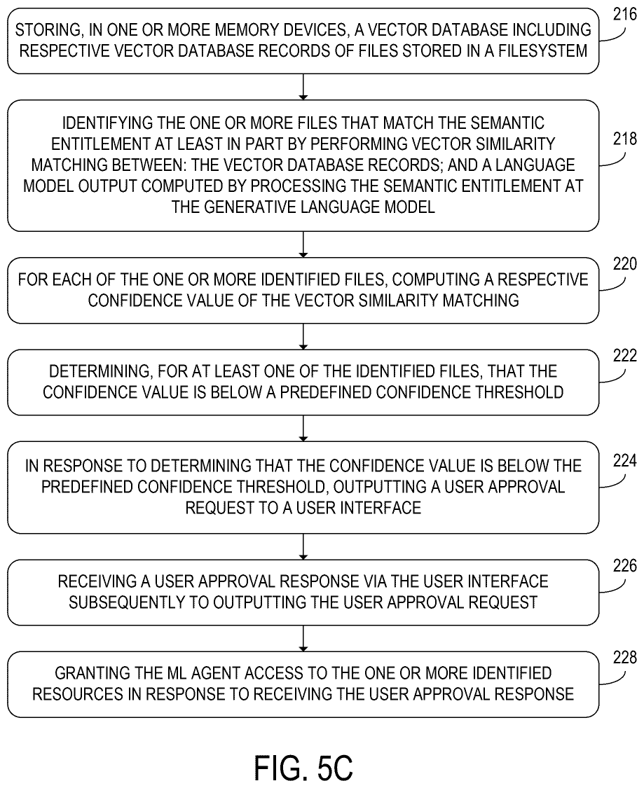

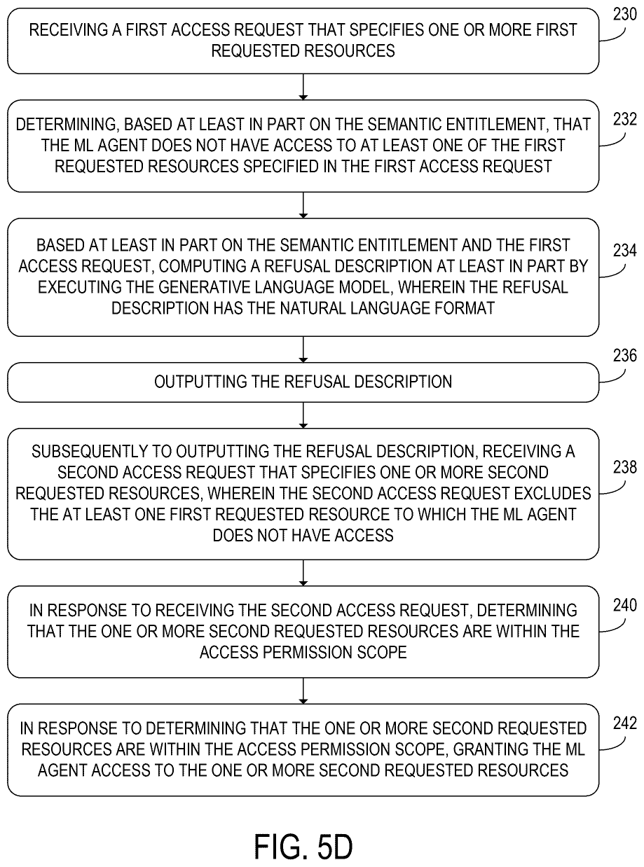

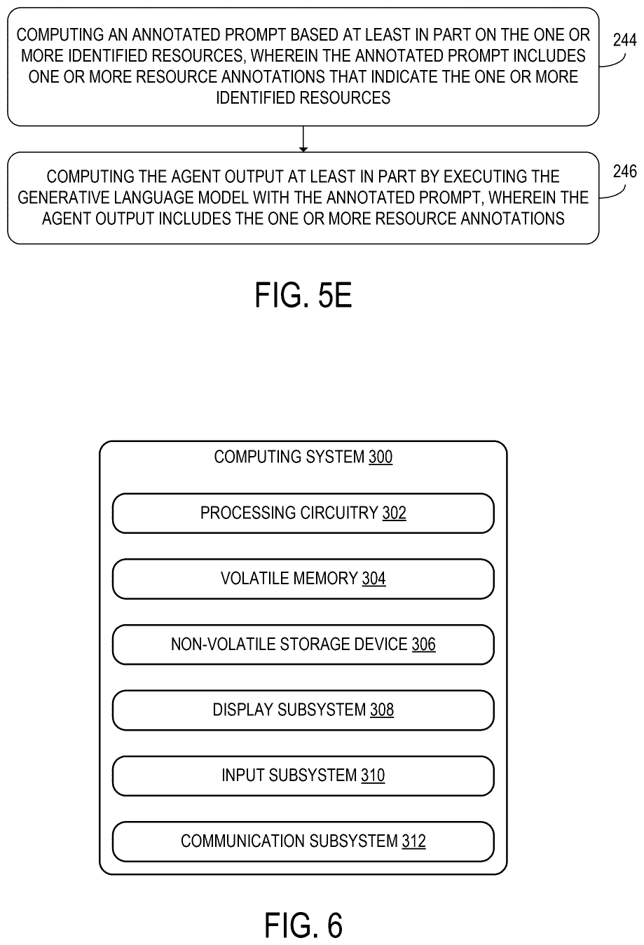

FIG. 5A shows a flowchart of a method 200 for use with a computing system at which an ML system is executed. The ML system includes a plurality of ML agents, each of which includes scaffolding code and one or more ML models. At step 202, the method 200 includes receiving a semantic entitlement that semantically specifies an access permission scope of an ML agent included in the ML system. The semantic entitlement has a natural language format. For example, the semantic entitlement may be a user input received at a user interface.

At step 204, the method 200 further includes identifying one or more resources that are included in the access permission scope indicated in the semantic entitlement. The one or more resources are identified at least in part by processing the semantic entitlement at a generative language model included in the ML system. The generative language model may also receive resource data as an input when computing the one or more identified resources. The resource data may include a list of a plurality of resources, such as a file stored in a filesystem at one or more memory devices, a network location in a computer network, an input data stream received at the computing system, and/or an output interface of the computing system.

In some examples, at step 204A, step 204 includes computing one or more access control lists (ACLs) that specify the one or more identified resources. In such examples, the ACLs are computed at least in part by processing the semantic entitlement at the generative language model, thereby making use of the code generation capabilities of the generative language model.

At step 206, the method 200 further includes granting an ML agent of the plurality of ML agents access to the one or more identified resources. At step 208, the method 200 further includes computing an agent output at the ML agent based at least in part on the one or more identified resources. For example, the one or more identified resources may be used as input to the one or more ML models included in the ML agent or may be used to select an output destination of the agent output. At step 210, the method 200 further includes outputting the agent output to an additional computing process. For example, the additional computing process may be another ML agent or a user interface.

FIGS. 5B-5E show additional steps of the method 200 that may be performed in some examples. The steps of FIG. 5B may be performed in some examples when performing step 204. At step 212, the method 200 may further include inputting, into the generative language model, entitlement policy metadata that specifies one or more access permission rules associated with the one or more resources. For example, the one or more access permission rules may include one or more ACLs and/or roles.

At step 214, the method 200 may further include identifying the one or more resources as matching the semantic entitlement based at least in part on a determination that the semantic entitlement satisfies the one or more access permission rules associated with the one or more resources. Thus, the semantic entitlement may be combined with rule-based systems of permission assignment when selecting the one or more identified resources.

FIG. 5C shows additional steps that may be performed in some examples. At step 216, the method 200 may further include storing, in one or more memory devices, a vector database including respective vector database records of files stored in a filesystem. For example, the vector database records may be computed at least in part by processing the files at a vectorization ML model.

At step 218, the method 200 may further include identifying the one or more files that match the semantic entitlement. The one or more files may be identified at least in part by performing vector similarity matching between the vector database records and a language model output, where the language model output is computed by processing the semantic entitlement at the generative language model. For example, cosine similarity matching may be performed at step 218.

In some examples, at step 220, the method 200 may further include computing a respective confidence value of the vector similarity matching for each of the one or more identified files. At step 222, in such examples, the method 200 may further include determining, for at least one of the identified files, that the confidence value is below a predefined confidence threshold. In response to determining that the confidence value is below the predefined confidence threshold, the method 200 may further include, at step 224, outputting a user approval request to a user interface.

In some examples, at step 226, the method 200 may further include receiving a user approval response via the user interface subsequently to outputting the user approval request. At step 228, the method 200 may further include granting the ML agent access to the one or more identified resources in response to receiving the user approval response.

In some examples, steps 224, 226, and 228 may be performed without also performing steps 216, 218, 220, and/or 222. Thus, in such examples, the computing system may request user approval in order to grant access to one or more identified resources even without computing the confidence values. In other examples, subsequently to performing step 222, the method 200 may further include denying the ML agent access to the at least one identified file that has a confidence value below the predefined confidence threshold.

FIG. 5D shows additional steps of the method 200 that may be performed in some examples. At step 230, the method 200 may further include receiving a first access request that specifies one or more first requested resources. The first access request is a request to grant the ML agent access to those first requested resources. For example, the first access request may be received at a user interface from a user whose role does not permit that user to define semantic entitlements.

At step 232, the method 200 may further include determining, based at least in part on the semantic entitlement, that the ML agent does not have access to at least one of the first requested resources specified in the first access request. Step 232 may include comparing each of the first requested resources to the set of one or more identified resources computed using the semantic entitlement.

At step 234, the method 200 may further include computing a refusal description at least in part by executing the generative language model. The refusal description has the natural language format and is computed based at least in part on the semantic entitlement and the first access request. At step 236, the method 200 may further include outputting the refusal description. The refusal description may be output to the user interface in order to give the user a natural-language description of why access to the first requested resource was refused.

In some examples, at step 238, the method 200 may further include receiving a second access request subsequently to outputting the refusal description. The second access request specifies one or more second requested resources. However, the second access request excludes the at least one first requested resource to which the ML agent does not have access. The user may input the second access request at the user interface as a revision of the first access request.

At step 240, in response to receiving the second access request, the method may further include determining that the one or more second requested resources are within the access permission scope. At step 242, in response to determining that the one or more second requested resources are within the access permission scope, the method 200 may further include granting the ML agent access to the one or more second requested resources.

FIG. 5E shows additional steps of the method 200 that may be performed in some examples. At step 244, the method 200 may further include computing an annotated prompt based at least in part on the one or more identified resources. The annotated prompt includes one or more resource annotations that indicate the one or more identified resources. In some examples, the semantic entitlement may also be included in the annotated prompt.

At step 246, the method 200 may further include computing the agent output at least in part by executing the generative language model with the annotated prompt. The agent output includes the one or more resource annotations. Thus, the ML system is configured to track the identified sources with which the agent output is generated, such as for debugging purposes.

Using the systems and methods discussed above, an ML agent included in an ML system is granted a semantic entitlement that defines, in natural language terms, the scope of resources to which the ML agent has access. Semantic entitlements allow users to specify sets of resources that would be cumbersome for the user to specify explicitly with ACLs or RBAC. In addition, semantic entitlements allow the computing system to make more informed determinations of when to request approval from users to access specific resources. In an ML system in which one or more ML agents are configured to access a large number of resources in a short amount of time, the semantic entitlement may be used to select which resources require user permission to access. For example, this determination may be made using confidence thresholds associated with the resources. Semantic entitlements may accordingly allow for more scalable access permission management in ML systems.

In one example use case scenario, the user is a patient who is using an ML agent to fill out a patient intake form in a medical setting. The patient's medical records include information about a first medical condition that the patient intends to discuss in the intake form. However, those medical records also discuss a second medical condition that the patient intends to omit from the intake form. The user accordingly inputs a semantic entitlement that states “Grant the form-filling agent access to medical records about [first condition] but not about [second condition].” A manager ML agent included in the ML system processes the semantic entitlement at a generative language model to obtain a set of identified resources. This set of identified resources includes information from the medical records about the first medical condition but not the information about the second medical condition. The manager ML agent then passes the set of identified resources to the form-filling agent, which uses them to complete a filled patient intake form.

In another example use case scenario, the ML system includes an administrative assistant ML agent that interacts with a videoconferencing application program. The administrative assistant ML agent is configured to generate output notifications and transmit those output notifications to the user. The user intends for the administrative assistant ML agent to be able to interrupt video calls when an emergency has occurred, but not under ordinary conditions. The user accordingly inputs the semantic entitlement “Make the administrative assistant ML agent capable of outputting to an ongoing video call, but only in emergencies.” During execution of the administrative assistant ML agent, the computing system may use semantic matching to determine when an emergency has occurred. For example, this determination may be made via vector similarity matching. When the administrative assistant ML agent determines that an output notification semantically matches an emergency condition, with confidence greater than a predefined confidence threshold, the administrative assistant ML agent utilizes the output interface of the videoconferencing application program to interrupt the video call. However, when the similarity value is below the predefined confidence threshold, the administrative assistant ML agent does not interrupt an ongoing video call with the output notification.

The methods and processes described herein are tied to a computing system of one or more computing devices. In particular, such methods and processes can be implemented as a computer-application program or service, an application-programming interface (API), a library, and/or other computer-program product.

FIG. 6 schematically shows a non-limiting embodiment of a computing system 300 that can enact one or more of the methods and processes described above. Computing system 300 is shown in simplified form. Computing system 300 may embody the computing system 10 described above and illustrated in FIGS. 1A-1B. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 6.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed, e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to receive a semantic entitlement that semantically specifies an access permission scope of a machine learning (ML) agent included in an ML system. The semantic entitlement has a natural language format. At least in part by processing the semantic entitlement at a generative language model included in the ML system, the one or more processing devices are further configured to identify one or more resources that are included in the access permission scope indicated in the semantic entitlement. The one or more processing devices are further configured to grant an ML agent of the plurality of ML agents access to the one or more identified resources. At the ML agent, the one or more processing devices are further configured to compute an agent output based at least in part on the one or more identified resources. The one or more processing devices are further configured to output the agent output to an additional computing process. The above features may have the technical effect of determining a scope of accessible resources for an ML agent in a semantically defined manner.

According to this aspect, each of the one or more identified resources may be a file stored in a filesystem at one or more memory devices, a network location in a computer network, an input data stream received at the computing system, or an output interface of the computing system. The above features may have the technical effect of setting the access permission scope over a variety of different types of resources.

According to this aspect, the one or more identified resources may include one or more files stored in the filesystem. The one or more memory devices may further store a vector database including respective vector database records of the one or more files. The one or more processing devices may be configured to identify the one or more files that match the semantic entitlement at least in part by performing vector similarity matching between the vector database records and a language model output computed by processing the semantic entitlement at the generative language model. The above features may have the technical effect of selecting the one or more identified resources using vector similarity matching.

According to this aspect, for each of the one or more identified files, the one or more processing devices are further configured to compute a respective confidence value of the vector similarity matching. The one or more processing devices may be further configured to determine, for at least one of the identified files, that the confidence value is below a predefined confidence threshold. In response to determining that the confidence value is below the predefined confidence threshold, the one or more processing devices may be further configured to output a user approval request to a user interface. The above features may have the technical effect of requesting user approval before granting the ML agent access to resources with low-confidence matches.

According to this aspect, the predefined confidence threshold may be included among a plurality of different predefined confidence thresholds associated with respective sets of available actions performable by the ML agent on the one or more identified files. The above features may have the technical effect of requiring different confidence levels in order to grant permission for the ML agent to perform different types of actions.

According to this aspect, the predefined confidence threshold may be included among a plurality of predefined confidence thresholds respectively associated with the files included in the filesystem. The above features may have the technical effect of setting different sensitivity levels for different files.

According to this aspect, the one or more processing devices may be further configured to output a user approval request to a user interface prior to granting the ML agent access to the one or more identified resources. The one or more processing devices may be further configured to receive a user approval response via the user interface subsequently to outputting the user approval request. The one or more processing devices may be further configured to grant the ML agent access to the one or more identified resources in response to receiving the user approval response. The above features may have the technical effect of requesting user approval prior to grating the ML agent access to the one or more identified resources.

According to this aspect, the one or more processing devices may be further configured to receive a first access request that specifies one or more first requested resources. The one or more processing devices may be further configured to determine, based at least in part on the semantic entitlement, that the ML agent does not have access to at least one of the first requested resources specified in the first access request. Based at least in part on the semantic entitlement and the first access request, the one or more processing devices may be further configured to compute a refusal description at least in part by executing the generative language model. The refusal description may have the natural language format. The one or more processing devices may be further configured to output the refusal description. The above features may have the technical effect of providing the user with a semantic explanation of why the first access request is denied.

According to this aspect, subsequently to outputting the refusal description, the one or more processing devices may be further configured to receive a second access request that specifies one or more second requested resources. The second access request excludes the at least one first requested resource to which the ML agent does not have access. In response to receiving the second access request, the one or more processing devices may be further configured to determine that the one or more second requested resources are within the access permission scope. In response to determining that the one or more second requested resources are within the access permission scope, the one or more processing devices may be further configured to grant the ML agent access to the one or more second requested resources. The above features may have the technical effect of granting a second access request that has been revised after the one or more processing devices output the refusal description.

According to this aspect, the one or more processing devices may be further configured to compute an annotated prompt based at least in part on the one or more identified resources. The annotated prompt may include one or more resource annotations that indicate the one or more identified resources. The one or more processing devices may be further configured to compute the agent output at least in part by executing the generative language model with the annotated prompt, wherein the agent output includes the one or more resource annotations. The above features may have the technical effect of tracking which resources are used to compute the agent output.

According to this aspect, during identification of the one or more resources that match the semantic entitlement, the one or more processing devices may be further configured to input, into the generative language model, entitlement policy metadata that specifies one or more access permission rules associated with the one or more resources. The one or more processing devices may be further configured to identify the one or more resources as matching the semantic entitlement based at least in part on a determination that the semantic entitlement satisfies the one or more access permission rules associated with the one or more resources. The above features may have the technical effect of setting access permissions for the ML agent using one or more discrete rules in addition to the semantic entitlement.

According to this aspect, by processing the semantic entitlement at the generative language model, the one or more processing devices may be configured to compute one or more access control lists (ACLs) that specify the one or more identified resources. The above features may have the technical effect of encoding the semantic entitlement into one or more ACLs.

According to another aspect of the present disclosure, a method for use with a computing system is provided. The method includes receiving a semantic entitlement that semantically specifies an access permission scope of a machine learning (ML) agent included in an ML system. The semantic entitlement has a natural language format. At least in part by processing the semantic entitlement at a generative language model included in the ML system, the method further includes identifying one or more resources that are included in the access permission scope indicated in the semantic entitlement. The method further includes granting an ML agent of the plurality of ML agents access to the one or more identified resources. The method further includes, at the ML agent, computing an agent output based at least in part on the one or more identified resources. The method further includes outputting the agent output to an additional computing process. The above features may have the technical effect of determining a scope of accessible resources for an ML agent in a semantically defined manner.

According to this aspect, each of the one or more identified resources may be a file stored in a filesystem at one or more memory devices, a network location in a computer network, an input data stream received at the computing system, or an output interface of the computing system. The above features may have the technical effect of setting the access permission scope over a variety of different types of resources.

According to this aspect, the one or more identified resources may include one or more files stored in the filesystem. The one or more memory devices may further store a vector database including respective vector database records of the one or more files. The method may further include identifying the one or more files that match the semantic entitlement at least in part by performing vector similarity matching between the vector database records and a language model output computed by processing the semantic entitlement at the generative language model. The above features may have the technical effect of selecting the one or more identified resources using vector similarity matching.

According to this aspect, for each of the one or more identified files, the method may further include computing a respective confidence value of the vector similarity matching. The method may further include determining, for at least one of the identified files, that the confidence value is below a predefined confidence threshold. In response to determining that the confidence value is below the predefined confidence threshold, the method may further include outputting a user approval request to a user interface. The above features may have the technical effect of requesting user approval before granting the ML agent access to resources with low-confidence matches.

According to this aspect, the method may further include receiving a first access request that specifies one or more first requested resources. The method may further include determining, based at least in part on the semantic entitlement, that the ML agent does not have access to at least one of the first requested resources specified in the first access request. Based at least in part on the semantic entitlement and the first access request, the method may further include computing a refusal description at least in part by executing the generative language model. The refusal description may have the natural language format. The method may further include outputting the refusal description. The above features may have the technical effect of providing the user with a semantic explanation of why the first access request is denied.

According to this aspect, the method may further include inputting, into the generative language model, entitlement policy metadata that specifies one or more access permission rules associated with the one or more resources. The method may further include identifying the one or more resources as matching the semantic entitlement based at least in part on a determination that the semantic entitlement satisfies the one or more access permission rules associated with the one or more resources. The above features may have the technical effect of setting access permissions for the ML agent using one or more discrete rules in addition to the semantic entitlement.

According to this aspect, the method may further include, by processing the semantic entitlement at the generative language model, computing one or more access control lists (ACLs) that specify the one or more identified resources. The above features may have the technical effect of encoding the semantic entitlement into one or more ACLs.

According to another aspect of the present disclosure, a computing system is provided, including one or more memory devices that store a filesystem including a plurality of files. The computing system further includes one or more processing devices configured to receive a semantic entitlement that semantically specifies an access permission scope of a machine learning (ML) agent included in an ML system. The semantic entitlement has a natural language format. The semantic entitlement is associated with the filesystem. At least in part by inputting the semantic entitlement into a generative language model included in the ML system, the one or more processing devices are further configured to identify one or more of the files stored in the filesystem that match the semantic entitlement. The one or more processing devices are further configured to identify one or more available actions performable on the one or more identified files. The one or more processing devices are further configured to grant an ML agent of the plurality of ML agents access to perform the one or more available actions on the one or more identified files that match the semantic entitlement. At the ML agent, the one or more processing devices are further configured to compute an agent output at least in part by performing an available action of the one or more available actions on the one or more identified files. The one or more processing devices are further configured to output the agent output to an additional computing process. The above features may have the technical effect of determining a scope of accessible resources for an ML agent in a semantically defined manner.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive a semantic entitlement that semantically specifies an access permission scope of a machine learning (ML) agent included in an ML system, wherein the semantic entitlement has a natural language format;
at least in part by processing the semantic entitlement at a generative language model included in the ML system, identify one or more resources that are included in the access permission scope indicated in the semantic entitlement;
grant an ML agent of the plurality of ML agents access to the one or more identified resources;
at the ML agent, compute an agent output based at least in part on the one or more identified resources; and
output the agent output to an additional computing process.

2. The computing system of claim 1, wherein each of the one or more identified resources is:
a file stored in a filesystem at one or more memory devices;
a network location in a computer network;
an input data stream received at the computing system; or
an output interface of the computing system.

3. The computing system of claim 2, wherein:
the one or more identified resources include one or more files stored in the filesystem;
the one or more memory devices further store a vector database including respective vector database records of the one or more files; and
the one or more processing devices are configured to identify the one or more files that match the semantic entitlement at least in part by performing vector similarity matching between:
the vector database records; and
a language model output computed by processing the semantic entitlement at the generative language model.

4. The computing system of claim 3, wherein the one or more processing devices are further configured to:
for each of the one or more identified files, compute a respective confidence value of the vector similarity matching;
determine, for at least one of the identified files, that the confidence value is below a predefined confidence threshold;
in response to determining that the confidence value is below the predefined confidence threshold, output a user approval request to a user interface.

5. The computing system of claim 4, wherein the predefined confidence threshold is included among a plurality of different predefined confidence thresholds associated with respective sets of available actions performable by the ML agent on the one or more identified files.

6. The computing system of claim 4, wherein the predefined confidence threshold is included among a plurality of predefined confidence thresholds respectively associated with the files included in the filesystem.

7. The computing system of claim 1, wherein the one or more processing devices are further configured to:
output a user approval request to a user interface prior to granting the ML agent access to the one or more identified resources;
receive a user approval response via the user interface subsequently to outputting the user approval request; and
grant the ML agent access to the one or more identified resources in response to receiving the user approval response.

8. The computing system of claim 1, wherein the one or more processing devices are further configured to:
receive a first access request that specifies one or more first requested resources;
determine, based at least in part on the semantic entitlement, that the ML agent does not have access to at least one of the first requested resources specified in the first access request;
based at least in part on the semantic entitlement and the first access request, compute a refusal description at least in part by executing the generative language model, wherein the refusal description has the natural language format; and
output the refusal description.

9. The computing system of claim 8, wherein the one or more processing devices are further configured to:
subsequently to outputting the refusal description, receive a second access request that specifies one or more second requested resources, wherein the second access request excludes the at least one first requested resource to which the ML agent does not have access;
in response to receiving the second access request, determine that the one or more second requested resources are within the access permission scope; and
in response to determining that the one or more second requested resources are within the access permission scope, grant the ML agent access to the one or more second requested resources.

10. The computing system of claim 1, wherein the one or more processing devices are further configured to:
compute an annotated prompt based at least in part on the one or more identified resources, wherein the annotated prompt includes one or more resource annotations that indicate the one or more identified resources; and
compute the agent output at least in part by executing the generative language model with the annotated prompt, wherein the agent output includes the one or more resource annotations.

11. The computing system of claim 1, wherein, during identification of the one or more resources that match the semantic entitlement, the one or more processing devices are further configured to:
input, into the generative language model, entitlement policy metadata that specifies one or more access permission rules associated with the one or more resources; and
identify the one or more resources as matching the semantic entitlement based at least in part on a determination that the semantic entitlement satisfies the one or more access permission rules associated with the one or more resources.

12. The computing system of claim 1, wherein, by processing the semantic entitlement at the generative language model, the one or more processing devices are configured to compute one or more access control lists (ACLs) that specify the one or more identified resources.

13. A method for use with a computing system, the method comprising:
receiving a semantic entitlement that semantically specifies an access permission scope of a machine learning (ML) agent included in an ML system, wherein the semantic entitlement has a natural language format;
at least in part by processing the semantic entitlement at a generative language model included in the ML system, identifying one or more resources that are included in the access permission scope indicated in the semantic entitlement;
granting an ML agent of the plurality of ML agents access to the one or more identified resources;
at the ML agent, computing an agent output based at least in part on the one or more identified resources; and
outputting the agent output to an additional computing process.

14. The method of claim 13, wherein each of the one or more identified resources is:
a file stored in a filesystem at one or more memory devices;
a network location in a computer network;
an input data stream received at the computing system; or
an output interface of the computing system.

15. The method of claim 14, wherein:
the one or more identified resources include one or more files stored in the filesystem;
the one or more memory devices further store a vector database including respective vector database records of the one or more files; and
the method further comprises identifying the one or more files that match the semantic entitlement at least in part by performing vector similarity matching between:
the vector database records; and
a language model output computed by processing the semantic entitlement at the generative language model.

16. The method of claim 15, further comprising:
for each of the one or more identified files, computing a respective confidence value of the vector similarity matching;
determining, for at least one of the identified files, that the confidence value is below a predefined confidence threshold;
in response to determining that the confidence value is below the predefined confidence threshold, outputting a user approval request to a user interface.

17. The method of claim 13, further comprising:
receiving a first access request that specifies one or more first requested resources;
determining, based at least in part on the semantic entitlement, that the ML agent does not have access to at least one of the first requested resources specified in the first access request;
based at least in part on the semantic entitlement and the first access request, computing a refusal description at least in part by executing the generative language model, wherein the refusal description has the natural language format; and
outputting the refusal description.

18. The method of claim 13, further comprising:
inputting, into the generative language model, entitlement policy metadata that specifies one or more access permission rules associated with the one or more resources; and
identifying the one or more resources as matching the semantic entitlement based at least in part on a determination that the semantic entitlement satisfies the one or more access permission rules associated with the one or more resources.

19. The method of claim 13, further comprising, by processing the semantic entitlement at the generative language model, computing one or more access control lists (ACLs) that specify the one or more identified resources.

20. A computing system comprising:
one or more memory devices that store a filesystem including a plurality of files;
one or more processing devices configured to:
receive a semantic entitlement that semantically specifies an access permission scope of a machine learning (ML) agent included in an ML system, wherein:
the semantic entitlement has a natural language format; and
the semantic entitlement is associated with the filesystem;
at least in part by inputting the semantic entitlement into a generative language model included in the ML system, identify:
one or more of the files stored in the filesystem that match the semantic entitlement; and
one or more available actions performable on the one or more identified files;
grant an ML agent of the plurality of ML agents access to perform the one or more available actions on the one or more identified files that match the semantic entitlement;
at the ML agent, compute an agent output at least in part by performing an available action of the one or more available actions on the one or more identified files; and
output the agent output to an additional computing process.
